(19) United States
(12) Patent Application Publication
(10) Pub. No.: US 2009/0044443 A1
(43) Pub. Date: Feb. 19, 2009

(54) Critter catcher

(76) Inventor: Michael C. Flaherty, Vienna, VA (US)

Correspondence Address: JAMES RAY & ASSOCIATES, 2640 PITCAIRN ROAD, MONROEVILLE, PA, 15146, US

(21) Appl. No.: 12/220,016

(22) Filed: Jul. 21, 2008

Related U.S. Application Data
(60) Provisional application No. 60/955,759, filed on Aug. 14, 2007.

(51) Int. Cl. A01M 3/00

(52) U.S. Cl. 43/110

(57) ABSTRACT

An apparatus enabling users to pick up and dispose of bugs, insects and other small creatures. The apparatus comprises a bubble member having an open bottom. A handle member is attached to an outer surface of the bubble member. A bottom tray member is slidingly engageable with a bottom portion of the bubble member for closing the open bottom. A grooved receptacle is disposed on a portion of the bottom for receiving the bottom tray when such bottom tray moves to open or close the bottom. A trigger is disposed adjacent a top portion of the handle and is engageable with the bottom tray for causing such bottom tray to move to an open or closed position when the trigger is depressed and to an opposite open or closed position when the trigger is released. A spring is engageable with the bottom tray and with the trigger for moving such bottom tray.

### CROSS REFERENCE TO RELATED APPLICATIONS

This application is closely related to and claims benefit from U.S. Provisional Application Ser. No. 60,955,759 filed Aug. 14, 2007.

### FIELD OF THE INVENTION

The present invention relates, in general, to a tool, and, more particularly, the present invention relates to a unique tool designed to enable users to pick up live or dead bugs, insects and small animals without having to touch them.

### BACKGROUND OF THE INVENTION

During warm summer months many homes are subject to an increase in the number and variety of bugs and insects that make their way inside a cool house. These infestations can also include a number of small animals such as mice, moles birds and even bats, which can all prove to be difficult to catch and dangerous to handle, whether dead or alive. Winter months can also note an increase of unwanted visitors causing a basement or attic to become new living quarters for a variety of small animals.

Many consumers are forced to put out traps to catch these small animals and must be removed with the hands, bare of with protective gloves if available. Without protective gloves, a rag or some other means for protecting the hands one can be scratched, bitten or even stung even if the animal is no longer alive. Also one must be very careful in handling these animals for fear of germs or infection from inadvertently touching them.

Thus, it would be advantageous if there were a simple and effective means of removing these bugs insects or small animals without the fear or danger of being injured or infected.

### SUMMARY OF THE INVENTION

In a first aspect the present invention provides an apparatus to enable users to pick up and dispose of bugs, insects, small animals, and other small creatures. The apparatus comprises a bubble member having an open bottom and each of a predetermined shape and a predetermined size and formed of a first predetermined material. A handle member is attached to an outer surface of the aid bubble member at a predetermined location for maneuvering such bubble member. A bottom tray member is slidingly engageable with a bottom portion of the bubble member for closing the open bottom of the bubble member, such bottom tray member is formed of a second predetermined material. A grooved receptacle is disposed on a predetermined portion of the bottom portion of the bubble member for receiving the bottom tray member when such bottom tray member moves to one of opening and closing the bottom of the bubble member. A trigger mechanism is disposed closely adjacent a top portion of the handle member and is further engageable with the bottom tray member for causing such bottom tray member to move to one of an open and a closed position when the trigger mechanism is depressed and to an opposite one of an open and closed position when the trigger mechanism is released. A biasing means is engageable with the bottom tray member and with the trigger mechanism for moving such bottom tray member to one of an open and a closed position when such trigger mechanism is depressed and to an opposite one of an open and closed position when such trigger mechanism is released.

### OBJECTS OF THE INVENTION

It is, therefore, one of the primary objects of the present invention to provide an apparatus for picking up and disposing live or dead bugs, insects and small animals.

Another object of the present invention is to provide an apparatus for removing these pests that does not require manual touching of these pests.

Still another object of the present invention is to provide an apparatus that has a hemispheric bubble to collect the unwanted pest.

Yet another object of the present invention is to provide an apparatus that has a handle and a trigger mechanism for opening and closing such hemispheric bubble.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a side perspective view of the apparatus according to an embodiment of the invention showing a bug in the bubble member with the tray closed to keep the bug inside.

FIG. 2 is a perspective view of the bubble member showing the tray being able to open and close.

FIG. 3 is a side perspective view of the of the apparatus showing a bug enclosed therein.

FIG. 4 is a side perspective view of the apparatus showing the trigger mechanism controlling the movement of the bottom tray member with the bottom tray member being closed on the left side and open in dotted lines on the right side of the bubble member.

FIG. 5 is a cutout view of the handle member showing a spring mechanism for causing the bottom tray member to either an open or closed position.

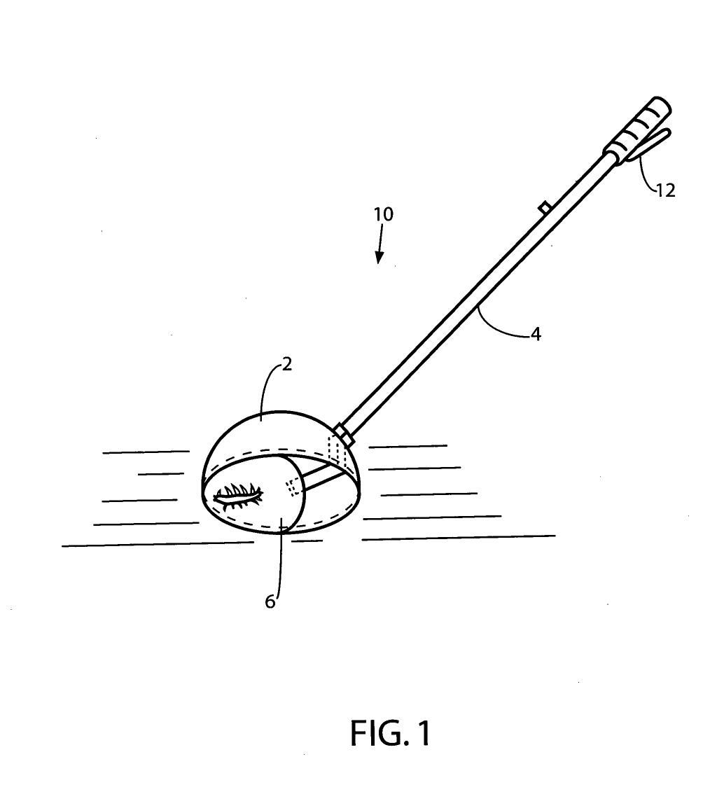

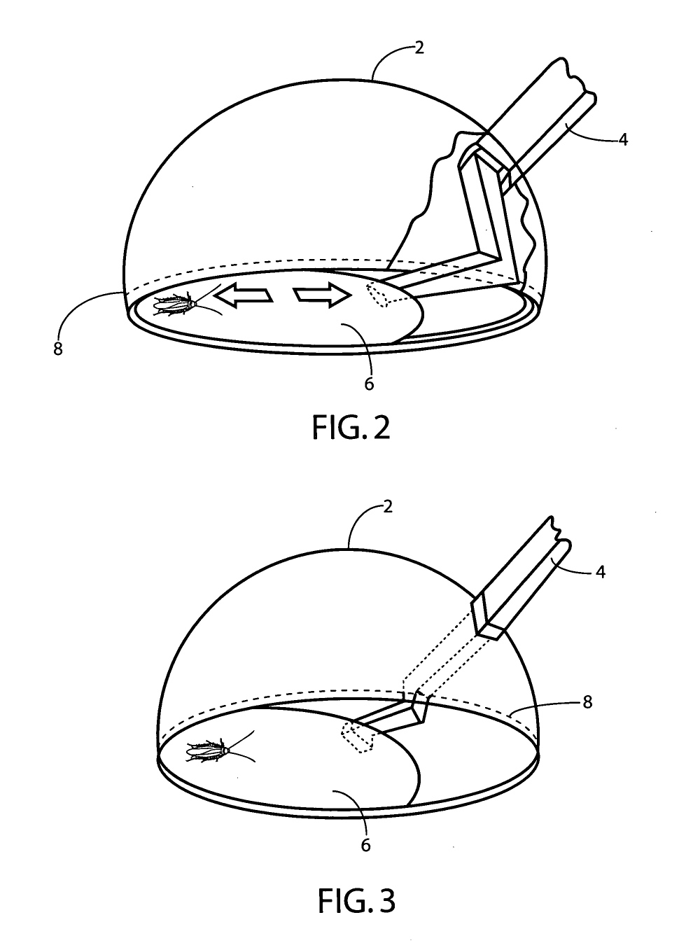

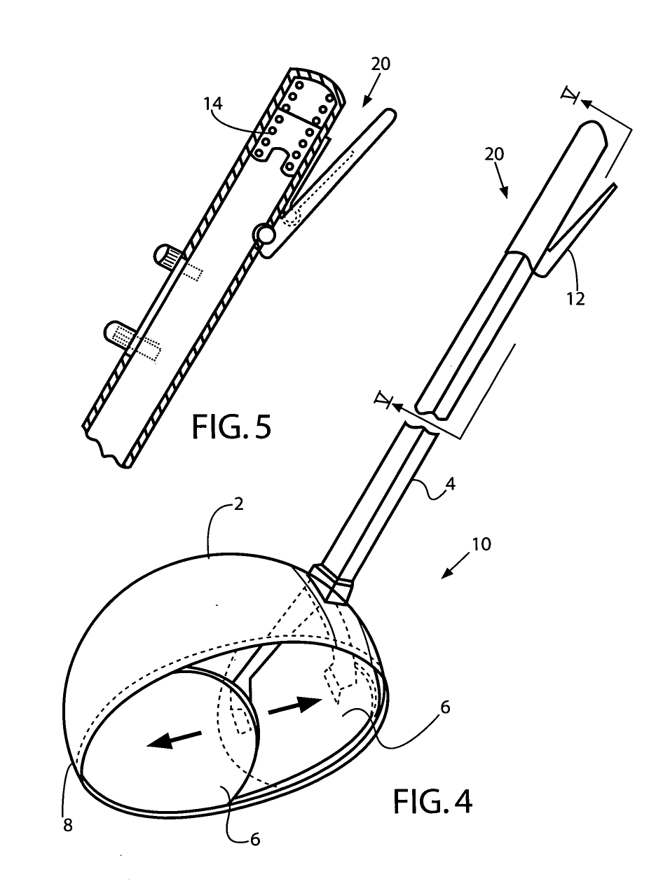

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, to enable users to pick up and dispose of bugs, insects, small animals, and other small creatures. The apparatus 10 comprises a bubble member 2 having an open bottom and each of a predetermined shape and a predetermined size and formed of a first predetermined material. A handle member 4 is attached to an outer surface of the bubble member 2 at a predetermined location for maneuvering such bubble member 2. A bottom tray member 6 is slidingly engageable with a bottom portion of the bubble member 2 for closing the open bottom of the bubble member 2, such bottom tray member 6 is formed of a second predetermined material. A grooved receptacle 8 is disposed on a predetermined portion of the bottom portion of the bubble member 2 for receiving the bottom tray member 6 when such bottom tray member 6 moves to one of opening and closing the bottom of the bubble member 2. A trigger mechanism 12 is disposed closely adjacent a top portion of the handle member 4 and is further engageable with the bottom tray member 6 for causing such bottom tray member 6 to move to one of an open and a closed position when the trigger mechanism 12 is depressed and to an opposite one of an open and closed position when the trigger mechanism 12 is released. A biasing means, generally designated 20, is engageable with the bottom tray member 6 and with the trigger mechanism 12 for moving such bottom tray member 6 to one of an open and a closed position when such trigger mechanism 12 is depressed and to an opposite one of an open and closed position when such trigger mechanism 12 is released. Such biasing means 20 includes a spring 14.

It is presently preferred that such predetermined shape of the bubble member 2 is one of circular and oval. It is even more preferred that such predetermined shape of the bubble member 2 is substantially hemispheric.

It is presently preferred that such first predetermined material for forming the bubble member 2 is plastic and that such predetermined location for attaching the handle member 4 to the bubble member 2 is a back portion of bubble member 2. It is also preferred that such bottom tray member 6 returns to a closed position when said trigger mechanism 12 is released. It is preferred that such trigger mechanism 12 is a squeeze type trigger 12.

Such handle member 4 is between about 2¾ and about 3¼ feet in length and it is preferable that such handle member 4 is substantially 3 feet in length. It is also within the scope of the invention that such length of the handle member 4 could be adjustable and that such adjustment would be a telescoping means.

The predetermined size of the bubble member 2 when such bubble member 2 is in a circular form is between about 4 and about 6 inches in diameter. The predetermined size of the bubble member 2 in an oval form is between about 4 and about 6 inches in length.

The second predetermined material for forming the tray member 6 is plastic and it is preferred that such plastic is transparent. It is also within the scope of the invention that such first and such second predetermined materials are similar.

Thus, the present invention provides a product specifically designed to pick up small bugs, insects, or other small animals, eliminating the need for the user to do so with his/her bare hands. The device comprises a hemispheric plastic “bubble” that is circular or oblong with a grooved receptacle close to the bottom for receiving a similarly sized and shaped plastic material tray that basically opens or closes the bottom of the bubble. The tray is controlled by a spring or similar tension or biasing means. The handle of the unit has a squeeze type trigger mechanism that controls the tray. An direct open/close activation enables the user to simply squeeze the trigger to open the tray and release the trigger to close the tray once the bug has been collected therein. A user of almost any age can use this apparatus by simply squeezing and releasing the trigger mechanism. The dead bug or insect can be disposed of as desired. The handle is approximately 3 feet long and the collection area measures about 4 to 6 inches.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus to enable users to pick up and dispose of bugs, insects, small animals, and other small creatures, said apparatus comprising:
(a) a bubble member having an open bottom and each of a predetermined shape and a predetermined size and formed of a first predetermined material;
(b) a handle member attached to an outer surface of said bubble member at a predetermined location for maneuvering said bubble member;
(c) a bottom tray member slidingly engageable with a bottom portion of said bubble member for closing said open bottom of said bubble member, said bottom tray member formed from a second predetermined material;
(d) a grooved receptacle disposed on a predetermined portion of said bottom portion of said bubble member for receiving said bottom tray member when said bottom tray member moves to one of opening and closing said bottom of said bubble member;
(e) a trigger mechanism disposed closely adjacent a top portion of said handle member and further engageable with said bottom tray member for causing said bottom tray member to move to one of an open and a closed position when said trigger mechanism is depressed and to an opposite one of said open and said closed position when said trigger mechanism is released; and
(f) a biasing means engageable with said bottom tray member and said trigger mechanism for moving said bottom tray member to said one of said open and said closed position when said trigger mechanism is depressed and to an opposite one of said open and said closed position when said trigger mechanism is released.

2. The apparatus, according to claim 1, wherein said biasing means includes a spring.

3. The apparatus, according to claim 1, wherein said predetermined shape of said bubble member is one of circular and oval.

4. The apparatus, according to claim 3, wherein said predetermined shape of said bubble member is substantially hemispheric.

5. The apparatus, according to claim 1, wherein said first predetermined material for forming said bubble member is plastic.

6. The apparatus, according to claim 1, wherein said predetermined location for attaching said handle member to said bubble member is a back portion of said bubble member.

7. The apparatus, according to claim 1, wherein said bottom tray member returns to a closed position when said trigger mechanism is released.

8. The apparatus, according to claim 1, wherein said handle member is substantially 3 feet in length.

9. The apparatus, according to claim 4, wherein said predetermined size of said bubble member is between about 4 and about 6 inches in diameter.

10. The apparatus, according to claim 3, wherein said predetermined size of said bubble member in an oval form is between about 4 and about 6 inches in length.

11. The apparatus, according to claim 1, wherein said trigger mechanism is a squeeze trigger.

12. The apparatus, according to claim 1, wherein a length of said handle member is adjustable.

13. The apparatus, according to claim 12, wherein said handle member is adjustable by a telescoping means.

14. The apparatus, according to claim 1, wherein said second predetermined material is plastic.

15. The apparatus, according to claim 14, wherein said plastic is transparent.

16. The apparatus, according to claim 1, wherein said first and said second predetermined material are similar.
